(19) United States
(12) Patent Application Publication
(10) Pub. No.: US 2014/0174298 A1
(43) Pub. Date: Jun. 26, 2014

(54) AIR FILTERING DEVICE

(71) Applicants: HON HAI PRECISION INDUSTRY CO., LTD., New Taipei (TW); FU DING ELECTRONICAL TECHNOLOGY (JIASHAN) CO.,LTD., Zhejiang (CN)

(72) Inventor: XIAO-LU OU, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/072,731

(22) Filed: Nov. 5, 2013

(30) Foreign Application Priority Data
Dec. 25, 2012 (CN) 2012207223308

(51) Int. Cl. B01D 47/06

(52) U.S. Cl. CPC B01D 47/06
USPC 96/240; 96/243; 96/367; 96/370

(57) ABSTRACT

An air filtering device includes a tank, a treatment house and a fan. The treatment house includes a base body covering the tank and a dividing board positioned in the base body. The dividing board is configured to divide the treatment house into a first treatment room and a second treatment room. An air intake is defined in the first treatment room. An air outlet is defined in the second treatment room. A guiding end is formed in an end of the boarding end adjacent to the tank. The fan is positioned adjacent to and facing the air outlet.

### BACKGROUND

1. Technical Field

The present disclosure generally relates to filtering devices, and particularly to an air filtering device in production departments.

2. Description of the Related Art

Air in production departments, especially in metal manufacturing departments, contains much dust. The dust contaminates the working environment, and affects usage lifetime of machines and health of workers adversely. A plurality of fans connected to extracting pipelines is positioned to directly draw the air out. However, the efficiency is relatively low. In addition, the extracting pipelines or ports need frequent cleaning

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an assembled, isometric view of an embodiment of an air filtering device.

FIG. 2 shows an exploded view of the air filtering device without a fan and a filter of FIG. 1.

FIG. 3 is an isometric cutaway view of the air filtering device without the fan and the filter of FIG. 1.

### DETAILED DESCRIPTION

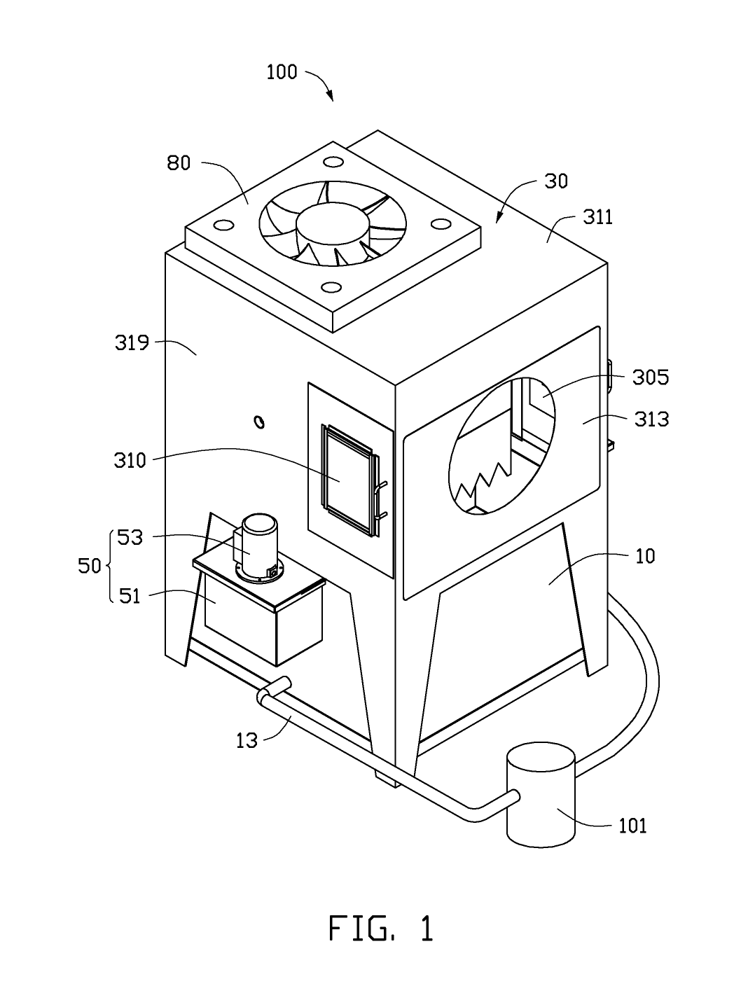

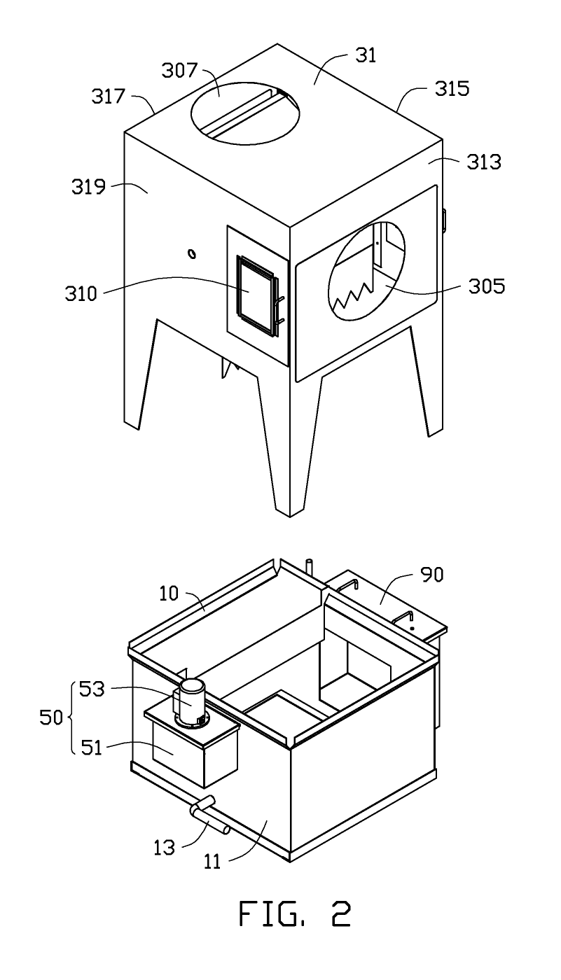

FIGS. 1 through 3 show an air filtering device 100 including a water tank 10, a treatment house 30, a pump 50, a spraying member 70, and a fan 80. The tank 10 is used for storing water. The tank 10 includes a tank body 11 and a pipe 13 mounted on and communicating with the tank body 11. The treatment house 30 covers the tank body 11, and includes a first treatment room 301 and a second treatment room 303 communicating with the first treatment room 301. An air intake 305 is defined through a sidewall of the first treatment room 301, and an air outlet 307 is defined in a sidewall of the second treatment room 303. The pump 50 is positioned on the outside of the tank 10 and communicates with the tank body 11. The spraying member 70 is positioned on a sidewall of the second treatment room 303, and communicates with and connects with the pump 50 for spraying water to purify air. The fan 80 is positioned on a top of the treatment house 10 and faces the air outlet 307, for extracting air.

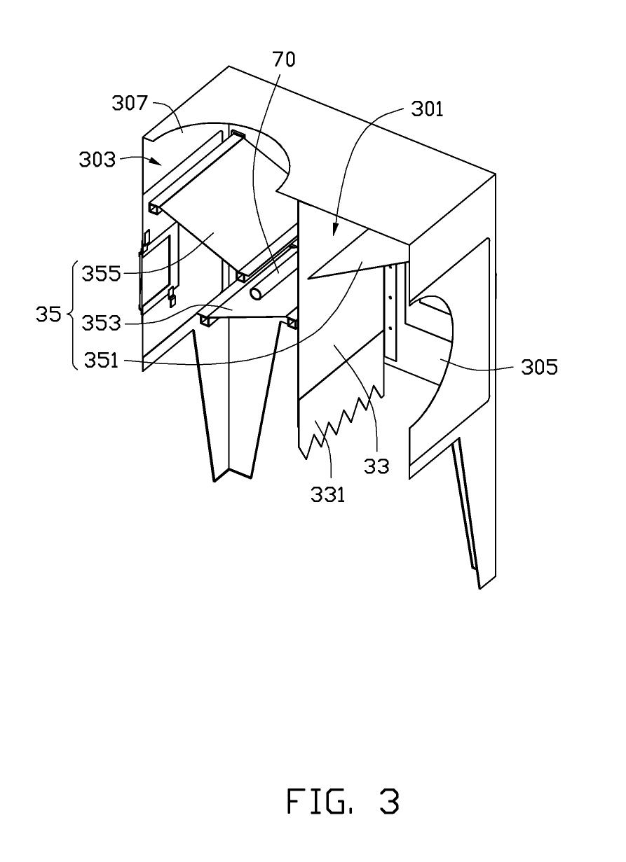

The treatment house 30 includes a base body 31, a dividing board 33 (as shown in FIG. 3), and a plurality of baffles 35 (as shown in FIG. 3). The base body 31 is a substantially hollow box and covers the tank body 11. The base body 31 includes a top wall 311, a first sidewall 313, a second sidewall 315, a third sidewall 317, and a fourth sidewall 319. The first, second, third, and fourth sidewall 313, 315, 317, 319 extend substantially perpendicularly from four edges of the top wall 311 toward the same direction. The first sidewall 313 and the third sidewall 317 are substantially parallel to each other, and the second sidewall 315 and the third sidewall 319 are substantially parallel to each other. Each of the second, third, and fourth sidewalls 315, 317, 319 defines a monitor window 310, which can be opened and closed for monitoring the internal portion of the treatment house 30. The air intake 305 is defined in the first sidewall 313, and the air outlet 307 is defined in the top wall 311 adjacent to the third sidewall 317 and communicating with an exhaust pipe (not shown).

The dividing board 33 protrudes substantially perpendicularly from the top wall 311 adjacent to the air outlet 307. The dividing board 33 is connected substantially perpendicularly with the second sidewall 315 and the fourth sidewall 319, and is located above the tank body 11. The dividing board 33 divides the treatment house 30 into the first treatment room 301 and the second treatment room 303. The air intake 305, the monitor windows 310 of the second and third sidewall 315, 317 are positioned in the first treatment room 301. The air outlet 307 and the monitor windows 310 of the first sidewall 313 are positioned in the second treatment room 303. A zigzag shaped guide end 331 is formed at an end of the dividing board 33 away from the top wall 311 to guide the flow and diffusion of the exhaust air in the treatment house 30.

A plurality of baffles 35 is positioned in the first and second treatment rooms 301, 303. In the illustrated embodiment, there is a first baffle 351, a second baffle 353, and a third baffle 355. The first baffle 351 is mounted on the first sidewall 313 above the air intake 305 and is received in the first treatment room 301. The second baffle 353 is positioned on the dividing board 33. The third baffle 355 is positioned on the third sidewall 317 above the second baffle 353. Both the second baffles 353, and the third baffles 355 are received in the second treatment room 303. The first, second, and third baffles 351, 353, 355 are inclined toward the tank body 11, for guiding droplets and the waste flow into the tank body 11. In other embodiments, the number and the installation positions of the baffles 35 can be positioned as needed.

The pump 50 is mounted on an external wall of the tank body 11 above the exhaust water pipe 11 and under the fourth sidewall 319. The pump 50 includes a container 51 and a pump body 53 mounted on the container 51. The container 51 is mounted on the external wall of the tank body 11 above the exhaust water pipe 11. The container 51 is connected with and communicates with the pump body 53.

The spraying member 70 is mounted on one internal sidewall of the second treatment room 303 above the third baffle 355, and connects with and communicates with the pump body 53. In the illustrated embodiment, the spraying member 70 is a spray pipe. A first end of the spraying member 70 is mounted on the fourth sidewall 319, and connects and communicates with the pump body 53 (not shown). The pump body 53 draws water from the container 51 to the spraying member 70.

The filtering device 100 further includes a water supplying tank 90. The water supplying tank 90 is positioned on an external sidewall of the tank body 11 opposite to the pump 50, such that the water supplying tank 90 is connecting and communicating with the tank body 11. A float level switch (not shown) is positioned in the water supplying tank 90 to detect the water level, such that the water supplying tank 90 supplies water to the tank body 11 when the water level of the water supplying tank 90 is lower than a preset level. The filtering device 100 can further include a filter 101. The filter 101 is connected between the exhaust water pipe 11 and the water supplying tank 90 to filtrate exhaust water for recycling water.

In assembly, the pump 50 is mounted on the external side wall of the tank body 11. The spraying member 70 is positioned in the second treatment room 303. The treatment house 30 is covered on the tank body 30. The spraying member 70 connects with and communicates with the pump 50. The fan 80 is positioned on the top wall 311 and faces the air outlet 307.

In use, water is stored in the tank body 11 and the water supplying tank 90. The dividing board 33 is positioned above the water. A gap (not labeled) is formed between the guide end 331 and water. The fan 80 and the pump 50 start, the exhaust gas enters the first treatment room 301, and strong adsorbing force is produced by the fan 80 and makes water in the tank body 11 spray to form mist. Dust or other contaminants in the air contact with and are absorbed by the mist. Water absorbed with dust remains in the first baffle 351 and sidewalls of the first treatment room 301. In addition, because of adsorption force produced by the fan 80, the exhaust air also enters the second treatment room 303. The spraying member 70 sprays water to form a water curtain to purify air. Dust and other contaminants in the air contact with and are absorbed by the water curtain.

The treatment house 30 is divided into the first treatment room 301 and the second treatment room 303 by the dividing board 33. The fan 80 generates water mist to purify the exhaust air, and the spraying member 70 sprays water to form a water curtain to purify the exhaust air. Because air is purified in the first and second treatment rooms 301, 303, which are closed, the efficiency is greatly improved. Emission remaining in the exhaust pipelines and exhaust port is decreased.

In other embodiments, the pump 50 and the spraying member 70 can be omitted, in other words, the filtering device 100 includes a tank 10, a treatment house 30, and a fan 80. The treatment house 30 includes a base body 31 and a dividing board 33. The base body 31 covers the tank 10. The dividing board 33 divides the treatment house 30 into the first treatment room 301 and the second treatment room 303. The guide end 331 is positioned at one end of the dividing board 33 adjacent to the tank 10. The air intake 305 is positioned on the first treatment room 30, and the air outlet 307 is positioned on the second treatment room 303. The fan 80 is positioned adjacent to the air outlet 307 and faces the air outlet 307.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. An air filtering device, comprising:
a tank;
a fan; and
a treatment house comprising a base body and a dividing board positioned in the base body, wherein the base body covers the tank, the dividing board divides the treatment house into a first treatment room and a second treatment room communicating with the first treatment room, an air intake is defined in the first treatment room, an air outlet air outlet is defined in the second treatment room, a guiding end is formed at an end of the dividing board adjacent to the tank for guiding air flow, and the fan is positioned adjacent to and facing the air outlet.

2. The air filtering device of claim 1, wherein the guide end has a zigzag shape.

3. The air filtering device of claim 1, wherein the air filtering device further comprises a spraying member mounted in the second treatment room.

4. The air filtering device of claim 3, wherein the air filtering device further comprises a pump mounted on an external wall of the tank, and the pump connects with and communicates with the spraying member and the tank.

5. The air filtering device of claim 4, wherein the pump comprises a container and a pump body mounted on the container, and the pump body connects with and communicates with the spraying member and the tank.

6. The air filtering device of claim 1, wherein the treatment house further comprises a plurality of baffles, one or more of the plurality of baffles are separately mounted and received in the first treatment room, and the remaining of the plurality of baffles are separately mounted and received in the second treatment room.

7. The air filtering device of claim 6, wherein the plurality of baffles is inclined toward the tank.

8. The air filtering device of claim 1, wherein a plurality of monitor windows is defined in external sidewalls of the base body spaced from the air intake and the air outlet.

9. The air filtering device of claim 1, wherein the air filtering device further comprises a water supplying tank positioned on a sidewall of the tank.

10. The air filtering device of claim 1, wherein the base body comprises a top wall, a first sidewall, a second sidewall, a third sidewall, and a fourth sidewall, the first sidewall, the second sidewall, the third sidewall and the fourth sidewall extend from four edges of the top wall substantially along a same direction, the air intake is defined in the first sidewall, the air outlet is defined in the top wall, and the fan is positioned on the top wall.

11. An air filtering device, comprising:
a tank;
a treatment house comprising a base body and a dividing board positioned in the base body, the base body covering the tank, the dividing board dividing the treatment house into a first treatment room and a second treatment room communicating with the first treatment room, an air intake being defined in the first treatment room, and an air outlet being defined in the second treatment room;
a fan positioned adjacent to and facing the air outlet;
a pump connecting with and communicating with the tank;
a spraying member mounted in the base body, and connecting with and communicating with the pump;
a water supplying tank connecting with and communicating with the tank; and
a filter connecting with and communicating with the tank and the water supplying tank for recycling water.

12. The air filtering device of claim 11, wherein a guiding end is formed at an end of the dividing board adjacent to the tank.

13. The air filtering device of claim 12, wherein the guide end has a zigzag shape.

14. The air filtering device of claim 11, wherein the pump comprises a container and a pump body mounted on the container, and the pump body connects with and communicates with the spraying member and the tank.

15. The air filtering device of claim 11, wherein the treatment house further comprises a plurality of baffles, one or more of the plurality of baffles are separately mounted and received in the first treatment room, and the remaining of the plurality of baffles are separately mounted and received in the second treatment room.

16. The air filtering device of claim 11, wherein the plurality of baffles is inclined toward the tank.

17. The air filtering device of claim 11, wherein a plurality of monitor windows is defined in sidewalls of the base body spaced from the air intake and the air outlet.

18. The air filtering device of claim 11, wherein the tank comprises a tank body and an exhaust water pipe mounted on and communicating with the tank body, and the filter connects between the exhaust water pipe and the water supplying tank.

19. The air filtering device of claim 11, wherein the base body comprises a top wall, a first sidewall, a second sidewall, a third sidewall, and a fourth sidewall, the first sidewall, the second sidewall, the third sidewall, and the fourth sidewall extend from four edges of the top wall substantially toward a same direction, the air intake is defined in the first sidewall, the air outlet is defined in the top wall, and the fan is positioned on the top wall.
